(19) United States
(12) Patent Application Publication
(10) Pub. No.: US 2005/0041011 A1
(43) Pub. Date: Feb. 24, 2005

(54) Method and user interface for entering text

(76) Inventors: Miika Silfverberg, Vantaa, (FI); Harri Wikberg, Helsinki (FI); Turkka Keinonen, Helsinki (FI)

Correspondence Address: Crawford Maunu, Suite 390, 1270 Northland Drive, Mendota Heights, MN, 55120, US

(21) Appl. No.: 10/496,917

(22) PCT Filed: Oct. 2, 2003
(86) PCT No.: PCT/FI03/00719

(30) Foreign Application Priority Data
Oct. 3, 2002 (FI) 2002/1759

(51) Int. Cl. G09G 5/00

(52) U.S. Cl. 345/156

(57) ABSTRACT

A method for entering text at a user interface for an electronic device, and a text entry user interface for an electronic device. The text entry user interface comprises a display for displaying characters and entered text, an input device for issuing commands to browse and select characters, and a processing unit for controlling the operation of the user interface. The processing unit is further configured to generate, for browsing, a character subset made up of characters to be browsed, the character subset including the characters of a character set from among which, according to an inference logic configured into the processing unit, the next character for the text is most probably selected, and display the character subset on the display for browsing the characters and for selecting the next character by using the input device.

### FIELD

The invention relates to a method for entering text at a user interface for an electronic device, and to a text entry user interface for an electronic device.

### BACKGROUND

Electronic devices, for instance subscriber terminals in a radio system, such as mobile telephones, are becoming smaller and smaller. At some point the keyboard of a device, for instance a 12-button character keyboard used in mobile telephones, will become useless since it becomes too difficult for a user to press buttons that are extremely small. It is thus the keyboard that becomes the limiting factor which starts to restrict the design of mobile telephones. If the keyboard could be replaced by another input device, it would be possible to manufacture mobile telephones of a considerably smaller size, even of miniature sizes.

A character keyboard can be replaced by various input devices. Nokia® 7110 mobile telephone, for example, employs a roller wherein the mobile telephone can be given different commands by rotating and pressing the roller.

A special problem with the use of an electronic device is the process of entering text. For instance, in ordinary mobile telephones employing a character keyboard, each button in the keyboard relates to several letters. A single button may, for instance, relate to the letters a, b and c. Pressing the button once produces the letter a, pressing the button twice within a short period of time produces the letter b, and pressing the button three times within a short period of time produces the letter c. Pressing the button twice slightly more slowly produces two a's. It is rather slow to use a keyboard in such a manner; therefore, various methods for entering text which employ a character keyboard have been developed; an example of such a method wherein an object is to identify a word entered by a user being disclosed in U.S. Pat. No. 5,818,437 (Tegic Communications), which is incorporated herein by reference.

An object of the invention disclosed by the present applicant is, however, to replace the character keyboard by another input device, which means that these prior art solutions cannot be used, at least not as such.

Some mobile telephones employ a solution wherein a user may browse a character string which includes the entire character set of the device, for instance in an alphabetical order, the characters then being selected one by one from this character string. The solution is rather slow, so different solutions have been provided thereto in publication Mobile Text Entry Using Three Keys by I. Scott MacKenzie, Proceedings of the Second Nordic Conference on Human Computer Interaction, NordiCHI 2002. In the solutions of the publication, a character string containing an entire character set is arranged in an order other than an alphabetical one in order to accelerate the process of entering text.

### BRIEF DESCRIPTION

An object of the invention is to provide an improved method for entering text at a user interface for an electronic device, and an improved text entry user interface for an electronic device.

An aspect of the invention presents a method for entering text at a user interface for an electronic device, comprising: browsing characters on a display; and selecting one of the browsed characters for the text. The method further comprises: generating, for browsing, a character subset made up of characters to be browsed, the character subset including the characters of a character set from among which, according to a predetermined inference logic, the next character for the text is most probably selected; and displaying the character subset on the display for browsing the characters and for selecting the next character.

An aspect of the invention presents a text entry user interface for an electronic device, comprising: a display for displaying characters and entered text; an input device for issuing commands to browse and select characters; and a processing unit for controlling the operation of the user interface, the processing unit being connected to the display and configured to display characters on the display, the processing unit being further connected to the input device and configured to receive, from the input device, commands to browse and select characters. The processing unit is further configured to: generate, for browsing, a character subset made up of characters to be browsed, the character subset including the characters of a character set from among which, according to an inference logic configured into the processing unit, the next character for the text is most probably selected; and display the character subset on the display for browsing the characters and for selecting the next character by using the input device.

Preferred embodiments of the invention are disclosed in the dependent claims.

The idea underlying the invention is that when an input device other than a character keyboard is used, text input must be enhanced one way or another. The procedure disclosed herein is based on using character subsets. After each entered character, a new character subset is generated applying a predetermined inference logic. Actually, the aim is thus not to predict an entire word but to try to guess the character the user most probably wishes to enter next.

The method and text entry user interface of the invention provide several advantages. The invention enables small electronic devices to be designed and manufactured, for instance when the keyboard is the limiting factor which prevents the sizes of the devices from being reduced. The use of a small input device enables an extremely good efficiency/size ratio to be achieved. The user interface is simple and intuitive and, in addition, designed for use with one hand.

### LIST OF DRAWINGS

The preferred embodiments of the invention will be described below by way of example and with reference to the accompanying drawings, in which

FIG. 1 is a simplified block diagram illustrating the structure of an electronic device;

FIGS. 2A to 2C show examples of different input devices;

FIG. 3 illustrates the implementation of an input device in an electronic device;

FIGS. 4A to 4E provide a sequence to illustrate how text is entered;

FIGS. 5A to 5E provide a sequence to illustrate browsing from a character subset to a character set;

FIG. 6 illustrates the layout of a display;

FIG. 7 illustrates the implementation of a stored main vocabulary having the form of a tree;

FIG. 8 is a flow diagram illustrating a method for entering text at a user interface for an electronic device;

FIGS. 9A to 9E provide a sequence to illustrate a process for inputting an entry; and

FIG. 10 illustrates a character subset and a character set.

### DESCRIPTION OF EMBODIMENTS

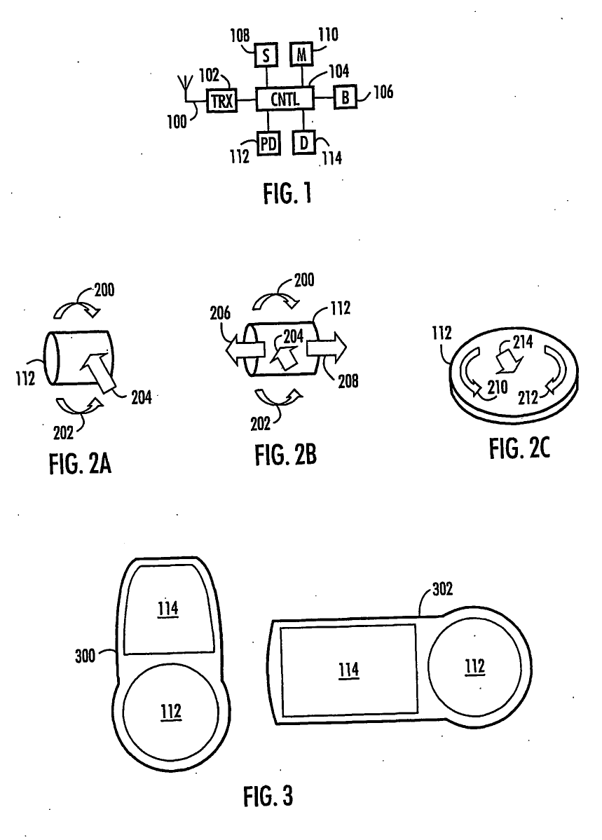

Referring to FIG. 1, an example is described of the structure of an electronic device. The device may be e.g. a portable device relating to Ubiquitous Computing, e.g. a subscriber terminal in a radio system, such as a mobile telephone system, a PDA (Personal Digital Assistant) device or another electronic device equipped with a text entry user interface. In our example of FIG. 1, the device is a subscriber terminal in a radio system. The example used being a subscriber terminal, the device comprises an antenna 100 and a radio transceiver 102. The radio transceiver 102 is e.g. a prior art transceiver for a mobile station, operating e.g. in a GSM (Global System for Mobile Communications) system, GPRS (General Packet Radio Service) system or in a UMTS (Universal Mobile Telecommunications System).

A rechargeable battery 106 usually serves as the power source for a subscriber terminal. The device further comprises a processing unit 104 to control and monitor the operation of the device and different parts thereof. The processing unit 104 further includes application software of the device, e.g. for radio signal processing, information processing and for controlling the operation of a user interface. The device thus comprises a memory in connection with the processing unit 104 for storing information. The memory can be implemented by known methods for implementing a non-volatile memory, e.g. as memory circuits and possibly as a small hard disk. Today, a processing unit 104 is usually implemented as a processor including its software, but different hardware configurations are also possible, e.g. a circuit built using separate logic components or one or more ASIC's (Application-Specific Integrated Circuit). If necessary, more than one processor may also be provided. A hybrid of these different implementation methods is also feasible. While selecting the mode of implementation, a person skilled in the art takes into account the requirements set for the size and power consumption of the device, the necessary processing capacity, manufacturing costs as well as manufacturing volumes.

The configuration of the processing unit 104 constitutes structural entities that can be implemented using a programming language, e.g. C programming language, C++ programming language, a machine language, or as software modules, also known as routines, encoded by an assembler. Compiled routines constitute software to be stored as a runnable version in a memory provided in connection with the processor and to be run by the processor. Instead of compiled programming languages, interpretable programming languages may also naturally be used, provided that their use fulfils the required processing rate and capacity. When the processing unit 104 is implemented as ASIC, the routines are ASIC blocks.

The subscriber terminal further includes, connected to the processing unit 104, components implementing the user interface: a microphone 110 and a loudspeaker 108 for processing voice, a display 114 for displaying information, and an input device 112 for controlling the device, for entering information and for issuing commands to process information.

The text entry user interface of the device is thus made up of the display 114 to display the characters and the entered text, the input device 112 to issue commands to browse and select the characters, and the processing unit 104 to control the operation of the user interface. The input device 112 for issuing commands to browse and select the characters is a pointing device other than a character keyboard. Typical examples of such pointing devices 112 include:
arrow buttons wherein browse commands are issued by pressing the arrow buttons;
a selection button wherein select commands are issued by pressing the selection button;
a joystick wherein browse and/or select commands are issued by moving the joystick;
a trackball wherein browse commands and/or select commands are issued by rotating the trackball, and/or wherein select commands are issued by pressing the trackball;
a touch pad wherein browse commands and/or select commands are issued by touching the touch pad.

FIG. 2A shows a roller 112 wherein browse commands can be issued by rotating the roller around its axis. The roller can be rotated in both directions 200, 202. The roller 112 may also be provided with a function of issuing select commands such that select commands may be issued by pressing the roller 112 in a direction 204. Nokia® 7110 mobile telephone, for example, employs such a three-way roller. The roller may also be implemented in a manner depicted in FIG. 2B wherein the roller is a five-way roller, i.e. in addition to the functions of the three-way roller, the roller 112 can also be moved in lateral directions 206 and 208.

FIG. 2C describes a disc 112 wherein browse commands may be issued by rotating the disc 112 coplanarly clockwise 212 and anti-clockwise 210. Furthermore, it is possible to issue select commands by pressing the disc 112. FIG. 2C only shows one pressing direction 214 but the disc 112 may also be provided with such features that presses at different points of the disc 112 can be separated from each other, in which case many different commands may be issued by pressing the disc 112. FIG. 3 describes an electronic device 300 to be used in a vertical direction, usually with one hand, in which case the display 114 and the disc are located one on top of the other. Furthermore, FIG. 3 shows a second electronic device 302 to be used in a horizontal position, usually with both hands, in which case the display 114 and the disc 112 are located side by side. An electronic device may also be a device to be used both in a vertical position and in a horizontal position. In such a case, the electronic device is provided with a select command to select the direction in which the device is to be used. The direction of the text to be displayed on the display 114 is determined according to the select command; similarly, the rotating directions and pressing points of the disc 112 may vary, depending on the position in which the device is used.

The processing unit 104 is connected to the display 114 and configured to display characters on the display 114. The processing unit 104 is also connected to the input device 112 and configured to receive, from the input device 112, commands to browse and select the characters. Furthermore, the processing unit 104 is configured to generate, for browsing, a character subset made up of characters to be browsed, the character subset including the characters of a character set from among which, according to an inference logic configured into the processing unit 104, the next character for the text is most probably selected, and to display the character subset on the display 114 for browsing the characters and for selecting the next character by using the input device 112.

Next, let us examine different inference logics.

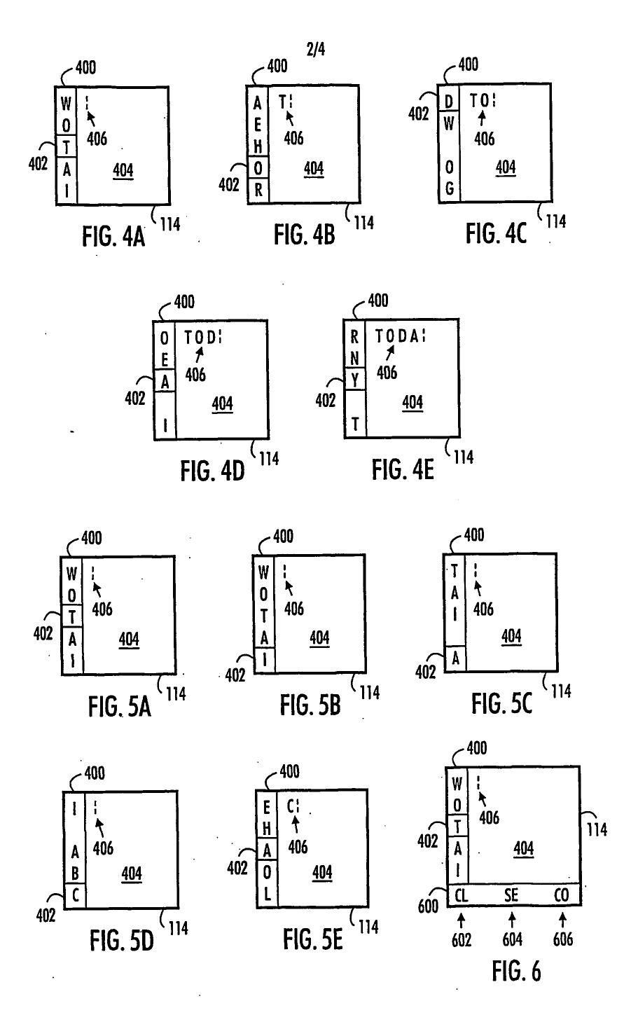

In an embodiment, the inference logic comprises a first routine for identifying a start of an entry of a new word, and a second routine for inserting, into the character subset, the most frequent word-starting letters of the language used in the text. This embodiment is described in FIG. 4A, according to which it has first been identified that a user wishes to start entering a new word. An entry of a new word is identified either by the user simply starting to enter text in the first place or by a previous character in the text being a space character, in which case it can be assumed that an entry of a new word will follow next. After the identification, a character subset 400 is displayed on the display 114, the character subset 400 in our example containing the five most frequent word-starting letters of the English language: T, A, O, I and W. The display 114 thus includes two areas: an area 400 for displaying a character subset and an area 404 for displaying entered text, a cursor 406 showing the place within the area 404 where the character to be entered next is to be placed.

FIG. 4A further illustrates an embodiment wherein the processing unit 104 is configured to display a selection pointer 402 on the display 114, the character (i.e. T) at the selection pointer 402 being selected by a select command, and to display the character subset such that prior to receiving the select command, the character of the character subset which most probably becomes selected resides at the selection pointer 402.

Still referring to FIG. 4A, it can be seen that the processing unit 104 is configured to display the character subset 400 as a character string. Tests conducted by the applicant suggest that preferably the character subset 400 includes three to six characters. As far as usability is concerned, it seems that a suitable compromise might be a character subset 400 which includes five characters since predicting becomes less successful using less than five characters but, on the other hand, more than five characters increase the visual search time for the user because not all characters can necessarily be seen at one time without moving the eyes and, furthermore, as the number of characters increases, the cognitive load increases as well. In our example, the letters of the character subset 400 have been arranged such that the most frequent letter T resides in the middle, and immediately at both sides of the most frequent letter are provided the next frequent letters A and O, I and W being the outermost letters. This enables the need to browse the characters to be minimized.

In an embodiment, the inference logic comprises a third routine for identifying, in the text being entered, letters relating to the word being entered, a fourth routine for identifying candidate words appropriate for the word being entered by using a stored main vocabulary of the language used, and a fifth routine for selecting, for the character subset 400, a character from each candidate word to be possibly entered next. A main vocabulary herein refers to a dictionary containing the most frequent words of the language used. Such a main vocabulary can be generated on the basis of a frequency list based on the frequency of words.

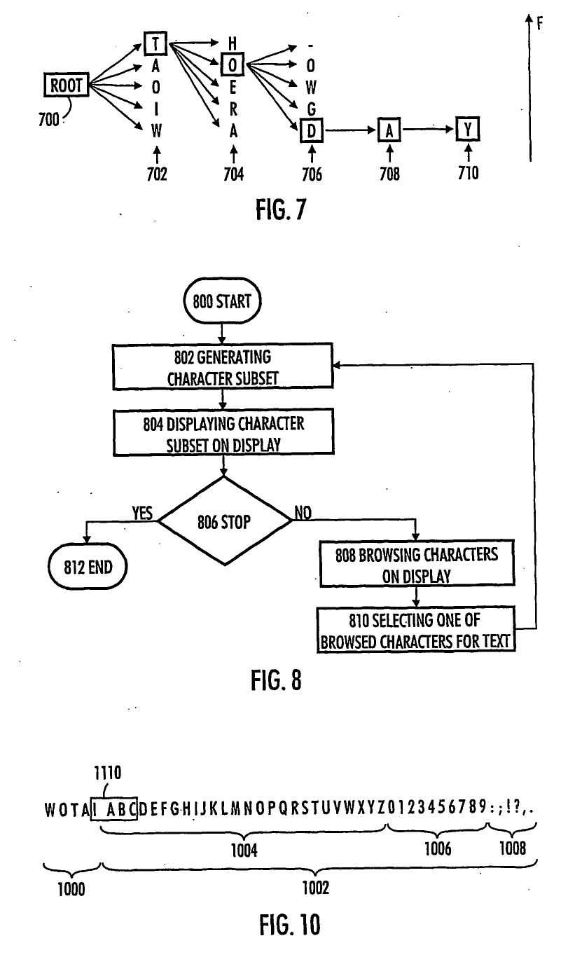

In the embodiment illustrated in FIG. 7, the words in the main vocabulary are arranged in the form of a tree such that a root 700 of the tree consists of a beginning of a word, the root being connected to nodes representing single characters on a next level 702, 704, 706, 708, 710 such that on each level, potential letters are, in order of frequency, connected to a node on a previous level whereby, as the process proceeds from the root of the tree through the nodes to a node on the last level, the characters in the nodes combine to form a word in the main vocabulary. FIG. 7 only illustrates a small part of the tree, i.e. the part which, using letters encircled in boxes, forms the word TODAY. The axis on the right-hand side of FIG. 7 describes frequency, i.e. on each level the letters are arranged in order of frequency such that the most frequent letter is the uppermost letter. The uppermost character on level 706 is a space character, i.e. the path leading thereto results in the word TO. In can also be seen in FIG. 7 that in the tree containing 9025 words used as an example herein, no alternatives are provided after the characters TOD but it is already known then that the user is probably entering the word TODAY.

Examine the sequence provided by FIGS. 4A to 4E in connection with FIG. 7, wherein the user is first in FIG. 4A shown the most frequent word-starting letters, i.e. the letters of the first level 702, as a character subset 400 WOTAI, from among which the user selects the letter T.

Next, in FIG. 4B, the user is shown the letters of the second level 704 as a character subset 400 AEHOR. The user moves a selection pointer 402 one character down and selects the letter O.

In FIG. 4C, the letters of the third level 706 are then shown as a character subset 400 DW OG. The processing unit 104 then receives browse commands by means of which the selection pointer 402 is moved on the display 114 to be the uppermost one in the character subset 400, i.e. at the letter D. Next, the processing unit 104 receives a select command, whereby the letter D at the selection pointer 402 is selected for the text being entered, i.e. it is added to the text 406 being entered, which is being displayed on the display 114, at the pointer.

In accordance with FIG. 7, only one letter, the letter A, exists on the fourth level 708. According to FIG. 4D, this is displayed at the selection pointer 402. FIG. 4D also illustrates an embodiment according to which the inference logic comprises a sixth routine for generating a character combination by using at least one character already used and a character to be possibly entered next, a seventh routine for checking the probabilities of different character combinations from a databank containing the probabilities of the different character combinations for the language used, and an eighth routine for selecting, for the character subset, a character from each most probable character combination to be possibly entered next. At its simplest, as far as only the alphabet of the English language is concerned, ignoring other characters, such as numbers or special characters, letter-pair frequencies, i.e. digraph frequencies, may be generated. The letter-pair frequencies can be presented as a two-dimensional table wherein the letters (27 letters including the space character in the English language, 30 letters in the Finnish language, for instance) are arranged on the vertical and horizontal axes while the cells of the table are provided with the frequency of each particular letter-pair. Since the previously entered letter was the letter D, it is possible to check the most frequent letter-pairs having the letter D as the first letter from the table: these letter-pairs are DE, DI and DO. The second letters of these letter-pairs are, in accordance with FIG. 4D, shown in the character subset 400, which thus consists of OEA I. The space character being a frequent character, in our example it has been positioned to be the most frequent alternative in the character subset 400 after the letter A before the second letters in the letter-pairs, i.e. before the letters E, I and O. In our example, from among the character subset 400 of FIG. 4D, the user selects the letter A residing at the selection pointer 402.

In accordance with FIG. 7, only one letter, the letter Y, remains on the fifth level 710 as well. In addition, according to FIG. 4E, a space character is again provided in the character subset 400, as well as the second letters of the most frequent letter-pairs AN, AT and AR starting with the letter A that was entered previously, i.e. the character subset 400 to be shown is thus RNY T. In our example, the user selects the letter Y from among the character subset of FIG. 4E, which is then added to the entered character string 406 at the cursor. Since next, using the main vocabulary, the entered word can be identified as TODAY and, next, the user may be shown IE OS as the character subset wherein the character in the middle is thus a space character while the four other characters are obtained from the letter-pair frequencies. It is thus easy for the user to select the space character. Next, the display 114 of FIG. 4A may be shown and an entry of a new word may begin.

FIG. 6 illustrates some possibilities of enhancing the layout of the display already shown in connection with FIGS. 4A to 4E. The display 114 thus contains the area 400 displaying a character subset, the selection pointer 402 as well as the area 404 displaying the text being entered, including the cursor 406. In addition, the display 114 may, according to FIG. 6, show a command bar 600 to display commands that are possible in a current state of the device. For example, if the display 114 according to FIG. 6 were placed in the device 300 described in FIG. 3, the operational logic could be slightly different, for instance such that the command bar 600 could show three commands 602, 604, 606 that are possible upon entering text. The first command 602 is for removing the character that was entered last, the second command 604 is for selecting the character located at the selection pointer 402, and the third command 606 is for implementing a word complete function. The word complete function can be implemented e.g. such that if, on the basis of characters already entered, only one word for which the characters are appropriate remains in the main vocabulary, the entire identified word will be shown on the display 114 by selecting the third command 606. For example, when in our example the word TODAY was being entered, according to FIG. 7, it can be inferred on the fourth level 708 that after the user has entered the letters TOD, he or is she probably has the word TODAY in mind, the word being shown on the display 114 by the third command 606. When the disc 112 of FIG. 3 is used, different commands can be implemented e.g. such that pressing the lefthand side of the disc 112 results in selecting the first command 602, pressing the middle of the disc 112 results in selecting the second command 604, and pressing the right-hand side of the disc 112 results in selecting the third command 606. The number of commands shown in the command bar 600 may vary, depending on whether the device is used in the vertical or in the horizontal position, as shown in FIG. 3. In the examples, the character subset 400 has been described as a character string made up of characters located on top of each other. A character string may also be generated using horizontal characters adjacent to each other (in which case the character subset looks like the one in a window 1110 to be described below in FIG. 10). The manner of representation of the character string may also vary depending on the position in which the device is used. The described method for entering text using a character subset may be an optional function of an electronic device which can be switched on/off e.g. by using an appropriate command in the command bar 600 or another selection mechanism enabled by a user interface for an electronic device.

In an embodiment, the processing unit 104 is configured such that in order to browse the characters on the display 114, the character subset is interlinked with the character set such that upon browsing past the character subset, the browsing of the character set begins. This embodiment will be described next with reference to the sequence provided by FIGS. 5A to 5E illustrating browsing from the character subset to the character set. As described above, FIG. 5A first shows a character subset 400 consisting of WOTAI.

The relation between a character subset 1000 and a character set 1002 is described in FIG. 10. All characters can be considered to form one long character string which is interlinked such that upon browsing past the end of the character subset, the process moves to the beginning of the character set; similarly, the interlinking may also operate such that upon browsing past the beginning of the character string, the process moves to the end of the character string. A character string made up of all characters thus constitutes a loop. In one long character string, the window 1110 is, in a manner of speaking, moved, and the contents of the window 1110 are displayed within the area 400 of the display 114. A character string thus includes a dynamic character subset 1000 and a static character set 1002 interlinked therewith. In our example, the character set 1002 is made up of letters 1004, numbers 1006 and the most frequent punctuation marks 1008. The composition of the character set 1002 may naturally vary depending on the application the process of entering text relates to. Commands can be associated with one long character string as well, in which case the user may select a command, e.g. removal of the previously entered character, by browsing onto the desired command in the long character string and by executing the selection.

In the example of FIG. 5, the user does not, however, wish to enter a word starting with the characters of the character subset 400. Therefore, he or she starts browsing downwards, i.e. according to FIG. 5B, the selection pointer has been moved at the letter I of the character subset. As the user browses further, the display starts scrolling up, in which case according to FIG. 5C, only three last characters TAI of the character subset remain to be seen, followed by characters of the character set, the first being the space character followed by the letter A. According to FIG. 5D, the scrolling continues until only the letter I from the character subset is shown on the display and, in addition to the space character, the letters A, B and C are shown from the character set; this situation is described in FIG. 10 by the window 1110. The user gives a select command using the input device 112, whereby the letter C at the selection pointer 402 is, according to FIG. 5E, conveyed into the area 404 displaying the entered text. In accordance with FIG. 5E, the character subset 400 is then displayed, the character subset 400 consisting of the letters E, H, A, O and L and being generated on the basis of the previously entered character, i.e. the letter C.

In an embodiment, the processing unit 104 is configured to display the interlinked character subset and character set on the display 114 in visually different manners. Visuality can be implemented e.g. such that the character subset is displayed using a first colour while the character set is displayed using a second colour. Different background colours may also be used. If no colours are available, or it is not desirable to use them, visuality may also be implemented in other ways by using e.g. different fonts: character subset characters may be bold and character set characters may be normal.

In order to enhance usability, the control may by default be determined to reside within the area 400 displaying the character subset. Thus, even though the selection pointer 402 were moved into the area of the character set, it would automatically return to the area 400 displaying the character subset after a character has been selected or after the character entered last has been removed. The selection pointer 402 may then also be moved to its default location.

In addition to entering words of a language, the procedure disclosed above can also be used for processing databases such that an entry in a database is entered by using the described method. A database may be e.g. a telephone book stored in the memory of a subscriber terminal. For example, the existing mobile telephones allow for over a thousand names and telephone numbers to be stored in their telephone books. A database may also be another database in need of a high-speed search mechanism. Examples of such databases include: databases used by navigation systems, wherein a destination has to be found out from among numerous places, street addresses, etc., as well as databases used in mobile e-commerce.

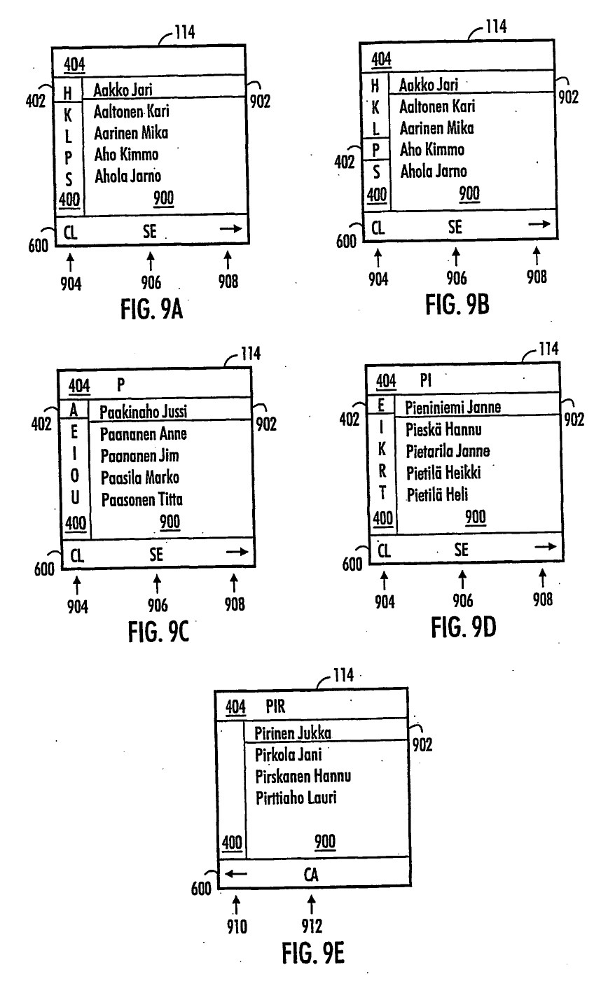

Next, referring to the sequence provided by FIGS. 9A to 9E, a process will be described for inputting an entry in order to process a database, i.e. in this case a telephone book. In our example, a name Pirskanen Hannu stored in the telephone book is searched for. Such a database may be stored e.g. in the form of a table in the memory located in connection with the processing unit 104. Different indexing techniques may also be needed to make the search fast enough. It is to be noted that the database to be processed does not, however, necessarily have to reside at the subscriber terminal but it may also reside e.g. in a network part of the mobile telephone system or at a server communicating with the network part.

In an embodiment, the inference logic comprises a ninth routine for identifying a start of an entry of a new word, and a tenth routine for inserting, into the character subset, the most frequent letters in a stored database starting an entry. This is described in FIG. 9A wherein a character subset 400 containing the character string HKLPS is displayed on the display 114. As distinct from what has been disclosed above, the letters of the character subset 400 have been arranged in an alphabetical order and the selection pointer 402 resides at the first letter.

In an embodiment, the inference logic comprises an eleventh routine for identifying, in the text being entered, letters relating to the word being entered, a twelfth routine for identifying entries in the stored database that are appropriate for the word being entered, and a thirteenth routine for selecting, for the character subset, a character from each entry to be possibly entered next. According to FIG. 9A, in an embodiment, the processing unit 104 is configured to display on the display 114, i.e. within an area 900, also the entries that most closely correspond with the word being entered. This embodiment is appropriate particularly when the database to be processed resides in an electronic device; if it resides somewhere else, in order to save data transfer capacity, it might be advisable not to display information within the area 900 until the amount of information to be transferred thereto has been filtered small enough due to the advancing process of entering text. The area 900 also has a selection pointer 902 of its own. The starting situation herein is, however, that since the user has not made a single selection yet, all entries in the telephone book are displayed within the area 900, which is only capable of showing first five names in an alphabetical order (last name first, forename second): Aakko Kari, Aaltonen Kari, Aarinen Mika, Aho Kimmo and Ahola Jamo. The display 114 is also provided with an area 404 to display the entered text. The display 114 also includes the above-described command bar 600. The command bar now contains three commands: a first command 904 to remove the character entered last, a second command 906 to select the character located at the selection pointer 402, and a third command 908 to move the control from the area 400 containing the character subset to the area 900 containing entries. Both the character subset and the entry set may thus be browsed.

In FIG. 9B, the user has moved the selection pointer 402 of the character subset 400 at the letter P.

In FIG. 9C, the user, using the input device 112, has given a select command when the selection pointer 402 resides at the letter P, whereby all names starting with the letter P are displayed in an alphabetical order within the area 900, which is capable of displaying only five such names: Paakinaho Jussi, Paananen Anne, Paananen Jim, Paasila Marko and Paasonen Titta. A character string AIEOU is shown as the character subset 400; this is based on the fact that the database contains a largest number of names starting with Pa, a next largest number of names starting with Pi, etc.

In FIG. 9D, the user has selected the letters PI, which are shown within the area 404 displaying the entered text, and the character subset 400 has been updated, now containing the letters EIKRT; this is based on the fact that the database contains a largest number of names starting with Pie, a next largest number of names starting with Pii, etc. All entries starting with Pi are now displayed within the area 900, which is only capable of showing five such names: Pieniniemi Janne, Pieskä Hannu, Pietarila Janne, Pietilä Heikki and Pietilä Heli.

In FIG. 9E, the user has selected the letters PIR, which are shown within the area 404 displaying the entered text. In our example, an empty set is shown as the character subset 400 since only four names remain, i.e. the names shown within the area 900: Pirinen Jukka, Pirkola Jani, Pirskanen Hannu and Pirttiaho Lauri. The control has been moved using an optional function from the area 400 automatically displaying the character subset to the area 900 displaying the entries. This transfer of control can also be left to be executed by the user using a particular command. As can be seen, the selection pointer 902 resides at the name Pirinen Jukka. The commands in the command bar 900 have also been updated: a fourth command 910 is used for returning from the area 900 to the area 400, and a fifth command 912 is used for starting a call to the person whose name resides at the selection pointer 902. The user thus needs to move the selection pointer 902 at the correct name Pirskanen Hannu and select the fifth command 912 by using the input device 112.

The five commands 904, 906, 908, 910, 912 used in our example can be implemented e.g. by the five-way roller described above in FIG. 2B. A movement sideways 206 implements the first command 904 when the control resides within the area 400, and the fourth command 910 when the control resides within the area 900. A movement sideways 208 implements the third command 908 when the control resides within the area 400. Rotation in the directions 200 and 202 implements movement of the selection pointer 402, 902 within whose area 400, 900 the control resides. Pressing the roller in the direction 204 implements the second command 906. It is obvious to a user interface designer that, depending on the conditions, the commands can be implemented as ergonomically as possible, using the different input devices described above.

Although not shown herein, the embodiment described above wherein upon browsing past the character subset the browsing of the character set begins can also be applied in connection with processing a database. In such a case, the character set contains the characters, i.e. an alphabet, with which the entries in the database may begin.

Next, referring to the flow diagram of FIG. 3, a method for entering text at a user interface for an electronic device will be described. The process starts in 800. Next, in 802, a character subset of the characters to be browsed is generated for browsing, the character subset including the characters of the character set from among which, according to a predetermined inference logic, the next character for the text is most probably selected. The character subset generated is displayed in accordance with 804 on the display for browsing the characters and for selecting the next character. In an embodiment, the character subset is displayed as a character string, the character subset including three to six characters, or five characters.

In 806, it is tested whether or not to stop the process of entering characters. If the process of entering characters is continued, the process moves to 808, wherein characters are browsed on the display and, furthermore, to 810, wherein one of the browsed characters is selected 810 for the text. Next, from 810 the process returns to 802. If the process of entering characters is to be stopped, the process moves from 806 to 812, wherein the execution of the method ends.

In an embodiment, the predetermined inference logic comprises: identifying a start of an entry of a new word, and inserting, into the character subset, the most frequent word-starting letters of the language used in the text.

In an embodiment, the predetermined inference logic comprises: identifying, in the text being entered, letters relating to the word being entered, identifying candidate words appropriate for the word being entered by using a stored main vocabulary of the language used, and selecting, for the character subset, a character from each candidate word to be possibly entered next.

In an embodiment, the words in the main vocabulary are arranged in the form of a tree such that a root of the tree consists of a beginning of a word. The root is connected to nodes representing single characters on a next level such that on each level, potential letters are, in order of frequency, connected to a node on a previous level. Then, as the process proceeds from the root of the tree through the nodes to a node on the last level, the characters in the nodes combine to form a word in the main vocabulary.

In an embodiment, the predetermined inference logic comprises: generating a character combination by using at least one character already used and a character to be possibly entered next, checking the probabilities of different character combinations from a databank containing the probabilities of the different character combinations for the language used, and selecting, for the character subset, a character from each most probable character combination to be possibly entered next.

In an embodiment, in order to browse the characters on the display, the character subset is interlinked with the character set such that upon browsing past the character subset, the browsing of the character set begins. The interlinked character subset and character set may be displayed on the display in visually different manners.

The method can also be applied to entering text in an application wherein the entered text generates an entry by which the desired information is found in a stored database. In an embodiment, the predetermined inference logic then comprises: identifying a start of an entry of a new word, and inserting, into the character subset, the most frequent letters in the stored database starting an entry. In an embodiment, the predetermined inference logic comprises: identifying, in the text being entered, letters relating to the word being entered, identifying entries in the database that are appropriate for the word being entered, and selecting, for the character subset, a character from each entry to be possibly entered next. The display may also display the entries that most closely correspond with the word being entered.

Suitable devices for executing the method include an electronic device of the type described above; however, other kind of devices which include a display and an input device as a user interface and which benefit from entering text in the above-described manner may also be suitable for executing the method.

Although the invention has been described above with reference to the examples according to the accompanying drawings, it is obvious that the invention is not restricted thereto but can be varied in many ways within the scope of the attached claims. In the examples, the use of the invention has been described using the Roman alphabet but the basic ideas can also be applied to other character sets as well, e.g. to Cyrillic characters, Greek characters, Hebrew characters or the like. The inference logic described in the examples operates on a word level but it can also be applied to a grammatical level.

1. A method for entering text at a user interface for an electronic device, comprising:
browsing characters on a display; and
selecting one of the browsed characters for the text;
generating, for browsing, a character subset made up of characters to be browsed, the character subset including the characters of a character set from among which, according to a predetermined inference logic, the next character for the text is most probably selected; and
displaying the character subset on the display for browsing the characters and for selecting the next character.

2. A method as claimed in claim 1, wherein the character subset is displayed as a character string.

3. A method as claimed in claim 1, wherein the character subset includes three to six characters.

4. A method as claimed in claim 1, wherein the character subset includes five characters.

5. A method as claimed in claim 1, wherein the predetermined inference logic comprises:
identifying a start of an entry of a new word; and
inserting, into the character subset, the most frequent word-starting letters of the language used in the text.

6. A method as claimed in claim 1, wherein the predetermined inference logic comprises:
identifying, in the text being entered, letters relating to the word being entered;
identifying candidate words appropriate for the word being entered by using a stored main vocabulary of the language used;
selecting, for the character subset, a character from each candidate word to be possibly entered next.

7. A method as claimed in claim 6, wherein the words in the main vocabulary are arranged in the form of a tree such that a root of the tree consists of a beginning of a word, the root being connected to nodes representing single characters on a next level such that on each level, potential letters are, in order of frequency, connected to a node on a previous level whereby, as the process proceeds from the root of the tree through the nodes to a node on the last level, the characters in the nodes combine to form a word in the main vocabulary.

8. A method as claimed in claim 1, wherein the predetermined inference logic comprises:
generating a character combination by using at least one character already used and a character to be possibly entered next;
checking the probabilities of different character combinations from a databank containing the probabilities of the different character combinations for the language used; and
selecting, for the character subset, a character from each most probable character combination to be possibly entered next.

9. A method as claimed in claim 1, wherein in order to browse the characters on the display, the character subset is interlinked with the character set such that upon browsing past the character subset, the browsing of the character set begins.

10. A method as claimed in claim 9, wherein the interlinked character subset and character set are displayed on the display in visually different manners.

11. A method as claimed in claim 1, wherein the predetermined inference logic comprises:
identifying a start of an entry of a new word; and
inserting, into the character subset, the most frequent letters in the stored database starting an entry.

12. A method as claimed in claim 1, wherein the predetermined inference logic comprises:
identifying, in the text being entered, letters relating to the word being entered;
identifying entries in the stored database that are appropriate for the word being entered; and
selecting, for the character subset, a character from each entry to be possibly entered next.

13. A method as claimed in claim 1, further comprising
displaying on the display also the entries that most closely correspond with the word being entered.

14. A text entry user interface for an electronic device, comprising:
a display for displaying characters and entered text;
an input device for issuing commands to browse and select characters; and
a processing unit for controlling the operation of the user interface, the processing unit being connected to the display and configured to display characters on the display, the processing unit being further connected to the input device and configured to receive, from the input device, commands to browse and select characters;
wherein the processing unit is further configured to:
generate, for browsing, a character subset made up of characters to be browsed, the character subset including the characters of a character set from among which, according to an inference logic configured into the processing unit, the next character for the text is most probably selected; and
display the character subset on the display for browsing the characters and for selecting the next character by using the input device.

15. A device as claimed in claim 14, wherein the processing unit is configured to display the character subset as a character string.

16. A device as claimed in claim 14, wherein the character subset includes three to six characters.

17. A device as claimed in claim 14, wherein the character subset includes five characters.

18. A device as claimed in claim 14, wherein the inference logic comprises:
a first routine for identifying a start of an entry of a new word; and
a second routine for inserting, into the character subset, the most frequent word-starting letters of the language used in the text.

19. A device as claimed in claim 14, wherein the inference logic comprises:
a third routine for identifying, in the text being entered, letters relating to the word being entered;
a fourth routine for identifying candidate words appropriate for the word being entered by using the stored main vocabulary of the language used;
a fifth routine for selecting, for the character subset, a character from each candidate word to be possibly entered next.

20. A device as claimed in claim 19, wherein the words in the main vocabulary are arranged in the form of a tree such that a root of the tree consists of a beginning of a word, the root being connected to nodes representing single characters on a next level such that on each level, potential letters are, in order of frequency, connected to a node on a previous level whereby, as the process proceeds from the root of the tree through the nodes to a node on the last level, the characters in the nodes combine to form a word in the main vocabulary.

21. A device as claimed in claim 14, wherein the inference logic comprises:
a sixth routine for generating a character combination by using at least one character already used and a character to be possibly entered next;
a seventh routine for checking the probabilities of different character combinations from a databank containing the probabilities of the different character combinations for the language used; and
an eighth routine for selecting, for the character subset, a character from each most probable character combination to be possibly entered next.

22. A device as claimed in claim 14, wherein the processing unit is configured such that for browsing the characters on the display, the character subset is interlinked with the character set such that upon browsing past the character subset, the browsing of the character set begins.

23. A device as claimed in claim 22, wherein the processing unit is configured to display the interlinked character subset and character set on the display in visually different manners.

24. A device as claimed in claim 14, wherein the inference logic comprises:
a ninth routine for identifying a start of an entry of a new word; and
a tenth routine for inserting, into the character subset, the most frequent letters in a stored database starting an entry.

25. A device as claimed in claim 14, wherein the inference logic comprises:
an eleventh routine for identifying, in the text being entered, letters relating to the word being entered;
a twelfth routine for identifying entries in the stored database that are appropriate for the word being entered; and
a thirteenth routine for selecting, for the character subset, a character from each entry to be possibly entered next.

26. A device as claimed in claim 14, wherein the processing unit is configured to display on the display also the entries that most closely correspond with the word being entered.

27. A device as claimed in claim 14, wherein the processing unit is configured to display a selection pointer on the display, the character residing at the selection pointer being selected by a select command, and to display the character subset such that prior to receiving a browse command, the character of the character subset which most probably becomes selected resides at the selection pointer.

28. A device as claimed in claim 14, wherein the input device for issuing commands to browse and select characters is a pointing device other than a character keyboard.

29. A device as claimed in claim 14, wherein the input device for issuing commands to browse and select characters comprises at least one of the following:
a roller wherein browse commands are issued by rotating the roller around its axis, and/or wherein select commands are issued by pressing the roller;
a disc wherein browse commands are issued by rotating the disc coplanarly clockwise and anti-clockwise, and/or wherein select commands are issued by pressing the disc;
arrow buttons wherein browse commands are issued by pressing the arrow buttons;
a selection button wherein select commands are issued by pressing the selection button;
a joystick wherein browse and/or select commands are issued by moving the joystick;
a trackball wherein browse commands and/or select commands are issued by rotating the trackball, and/or wherein select commands are issued by pressing the trackball; and
a touch pad wherein browse commands and/or select commands are issued by touching the touch pad.
